(19) United States
(12) Patent Application Publication
(10) Pub. No.: US 2014/0156339 A1
(43) Pub. Date: Jun. 5, 2014

(54) OPERATIONAL RISK AND CONTROL ANALYSIS OF AN ORGANIZATION

(71) Applicant: BANK OF AMERICA CORPORATION, Charlotte, NC (US)

(72) Inventors: Carol A. Boyer, Whittier, NC (US); Stephen A. Corrado, Cold Spring, NY (US); Paula E. Pottle, Pine Plains, NY (US); Nooruddin Rahimi, Dallas, TX (US); Richard Warren Simpson, Lancaster, SC (US)

(73) Assignee: Bank of America Corporation, Charlotte, NC (US)

(21) Appl. No.: 13/692,297

(22) Filed: Dec. 3, 2012

(51) Int. Cl. G06Q 10/06

(52) U.S. Cl. CPC G06Q 10/0635
USPC 705/7.28

(57) ABSTRACT

Systems and methods that facilitate operational risk and control analysis of an organization may include receiving a plurality of key risks and the plurality of key risks identify operational risks of an organization. A plurality of sets of data is received from a plurality of data providers, and the plurality of the sets of data comprise information associated with a plurality of business units in the organization. Each set of data is associated with a key risk, and the plurality of the sets of data is compiled based on the key risk. The compiled data is quantified, and quantifying the integrated data comprises weighting the compiled data according to the key risk. The quantified data is stored to facilitate risk analysis.

### TECHNICAL FIELD OF THE INVENTION

This invention relates generally to risk analysis, and more particularly to operational risk and control analysis of an organization.

### BACKGROUND OF THE INVENTION

Organizations analyze data to reduce the level of risk that may impact the organization. In isolation, each business unit may analyze the risk affecting their business unit. However, analyzing the risk of the business unit in isolation does not provide a full risk analysis for the organization's use.

### SUMMARY OF THE INVENTION

According to embodiments of the present disclosure, disadvantages and problems associated with operational risk and control analysis of an organization may be reduced or eliminated.

In certain embodiments, systems and methods that facilitate operational risk and control analysis of an organization may include receiving a plurality of key risks and the plurality of key risks identify operational risks of an organization. A plurality of sets of data is received from a plurality of data providers, and the plurality of the sets of data comprise information associated with a plurality of business units in the organization. Each set of data is associated with a key risk, and the plurality of the sets of data is compiled based on the key risk. The compiled data is quantified, and quantifying the integrated data comprises weighting the compiled data according to the key risk. The quantified data is stored to facilitate risk analysis.

Certain embodiments of the present disclosure may provide one or more technical advantages. A technical advantage of one embodiment includes providing a system that facilitates the analysis of risk across various business units of an organization. Having the ability to analyze data across various business units facilitates a broader risk analysis. Another technical advantage of an embodiment includes analyzing data that is internal to the organization and analyzing data that is external to the organization. Again, broadening the scope of the analysis allows the organization to better understand potential risks and respond accordingly. Yet another technical advantage includes electronically gathering information from electronic data providers to provide current information regarding the external organizations, which provides more complete and accurate information for the risk analysis. Another technical advantage of an embodiment includes prioritizing the areas for improvement opportunities to facilitate development of an action plan.

Certain embodiments of the present disclosure may include some, all, or none of the above advantages. One or more other technical advantages may be readily apparent to those skilled in the art from the figures, descriptions, and claims included herein.

### BRIEF DESCRIPTION OF THE DRAWINGS

To provide a more complete understanding of the present invention and the features and advantages thereof, reference is made to the following description taken in conjunction with the accompanying drawings, in which:

FIG. 1 illustrates a block diagram of an embodiment of a system for operational risk and control analysis of an organization;

FIG. 2 illustrates a flowchart for operational risk and control analysis of an organization; and

FIG. 3 illustrates a chart that provides information regarding the quantification of integrated data.

### DETAILED DESCRIPTION OF THE INVENTION

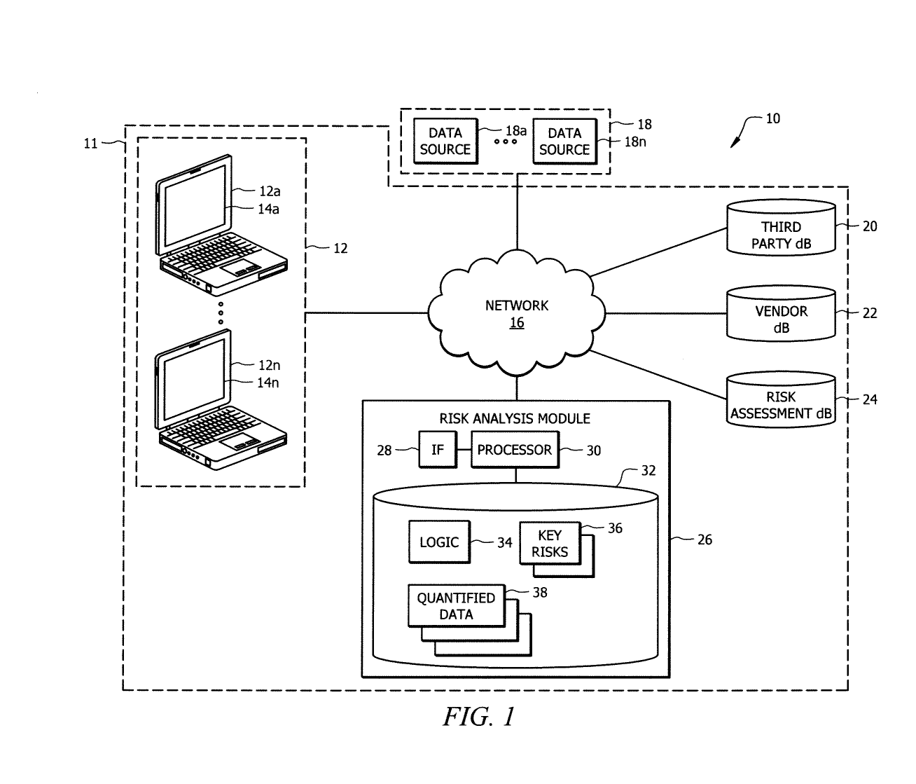

Embodiments of the present invention and its advantages are best understood by referring to FIGS. 1 through 3 of the drawings, like numerals being used for like and corresponding parts of the various drawings.

Organizations analyze data to reduce the level of risk that may impact the organization. In isolation, each business unit may analyze the risk affecting their business unit. However, analyzing the risk of the business unit in isolation does not provide a full risk analysis for the organization's use. Therefore, a system and method is needed to analyze risk across multiple business units in an organization together, which can provide a more complete risk analysis of the organization.

FIG. 1 illustrates a block diagram of an embodiment of a system 10 for operational risk and control analysis of an organization. System 10 includes computers 12, data sources 18, a third party database 20, a vendor database 22, and a risk assessment database 24 that communicate over one or more networks 16 with risk analysis module 26 to facilitate the analysis of risk in organization 11. System 10 implements a mapping approach on information to determine how data maps to key risks and quantifies the mapped data for risk analysis.

In the illustrated embodiment, organization 11 comprises computers 12, third party database 20, vendor database 22, risk assessment database 24, and risk analysis module 26. Organization 11 represents an entity in any suitable industry that manages risk. Organization 11 may include companies of any suitable size that evaluate operational risk to manage and identify risk of the organization. Third parties may include any suitable entity that is external to organization 11, such as vendors of organization 11, competitors of organization 11, or entities in industries different from organization 11.

System 10 includes computers 12a-12n, where n represents any suitable number, that communicate with risk analysis module 26 through network 16. For example, computer 12 communicates with risk analysis module 26 to identify the sources from which to compile the data. As another example, computers 12 receive analyzed data from risk analysis module 26. As yet another example, computer 12 communicates key risks to risk analysis module 26 for use in mapping the data. Computer 12 may include a personal computer, a workstation, a laptop, a wireless or cellular telephone, an electronic notebook, a personal digital assistant, a smartphone, a netbook, a tablet, a slate personal computer, or any other device (wireless, wireline, or otherwise) capable of receiving, processing, storing, and/or communicating information with other components of system 10. Computer 12 may also comprise a user interface, such as a display, keyboard, mouse, or other appropriate terminal equipment.

In the illustrated embodiment, computer 12 includes a graphical user interface (“GUI”) 14 that displays information received from risk analysis module 26. For example, GUI 14 may display data mapped to a key risk in a particular format to a user of computer 12. As another example, GUI 14 may display quantified data in a particular format to a user of computer 12. GUI 14 is generally operable to tailor and filter data entered by and presented to the user. GUI 14 may provide the user with an efficient and user-friendly presentation of information using a plurality of displays having interactive fields, pull-down lists, and buttons operated by the user. GUI 14 may include multiple levels of abstraction including groupings and boundaries. It should be understood that the term GUI 14 may be used in the singular or in the plural to describe one or more GUIs 14 in each of the displays of a particular GUI 14.

Network 16 represents any suitable network operable to facilitate communication between the components of system 10, such as computers 12, data sources 18, third party database 20, vendor database 22, risk assessment database 24, and risk analysis module 26. Network 16 may include any interconnecting system capable of transmitting audio, video, signals, data, messages, or any combination of the preceding. Network 16 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components.

Data sources 18 represent components that are external to organization 11 that provide data associated with organization 11 and/or third parties to risk analysis module 26. Data sources 18 may provide unbiased, independent information for analysis. For example, data source 18 may include regulatory filings associated with third parties or organization 11, such as filings made with the Security Exchange Commission (e.g., 10 Ks and 10 Qs). Data source 18 may also include press releases, news, events, or any other digital media that may be related to organization 11 or a third party. Additionally, data sources 18 may include independent professional research materials. In an embodiment, data sources 18 are chosen based on the maximum potential to identify external operational risks based on unstructured data content and searchable databases. Therefore, data sources 18 are scanned for targeted, repeatable information. In an exemplary embodiment, data sources 18 provide information associated with industry competitors of organization 11; information regarding new and emerging products and/or technologies; information regarding legal, regulatory, and/or geopolitical trends; information regarding major suppliers of organization 11 and its industry competitors; and information regarding competitors and/or potential competitors in different industries.

Data sources 18 may include a network server, any suitable remote server, a mainframe, a host computer, a workstation, a web server, a personal computer, a file server, or any other suitable device operable to communicate with other components in system 10 and process data. In some embodiments, data source 18 may execute any suitable operating system such as IBM's zSeries/Operating System (z/OS), MS-DOS, PC-DOS, MAC-OS, WINDOWS, a .NET environment, UNIX, OpenVMS, or any other appropriate operating system, including future operating systems. The functions of data source 18 may be performed by any suitable combination of one or more servers or other components at one or more locations. In the embodiment where the module is a server, the server may be a private server, and the server may be a virtual or physical server. Also, data source 18 may include any suitable component that functions as a server.

Third party database 20 stores, either permanently or temporarily, information associated with competitors of organization 11. Third party database 20 is within organization 11 and represents information that organization 11 compiles associated with third parties. The information stored in third party database 20 may include, but is not limited to, press release information, regulatory filing information, professional research materials, or other suitable third party analysis information. Risk analysis module 26 may communicate with third party database 20 to receive information associated with third parties. Third party database 20 includes any one or a combination of volatile or non-volatile local or remote devices suitable for storing information. For example, third party database 20 may include Random Access Memory (RAM), Read Only Memory (ROM), magnetic storage devices, optical storage devices, or any other suitable information storage device or combination of these devices.

Vendor database 22 stores, either permanently or temporarily, information associated with vendors of organization 11. Vendor database 22 is within organization 11 and represents information that organization 11 compiles associated with its vendors. The information stored in vendor database 22 may include, but is not limited to, press release information, regulatory filing information, professional research materials, performance information, relationship information, financial data, or other suitable vendor analysis information. Risk analysis module 26 may communicate with vendor database 22 to receive information associated with vendors of organization 11. Vendor database 22 includes any one or a combination of volatile or non-volatile local or remote devices suitable for storing information. For example, vendor database 22 may include RAM, ROM, magnetic storage devices, optical storage devices, or any other suitable information storage device or combination of these devices.

Risk assessment database 24 stores, either permanently or temporarily, information associated with risk assessments of organization 11. Risk assessment database 24 is within organization 11 and represents information that organization 11 compiles regarding itself. The information stored in risk assessment database 24 may include, but is not limited to, information related to technology incidents, corporate security events, information security events, privacy events, organizational operational losses, audit issues, risk control self assessments, or any other suitable information involved in risk assessment. Risk analysis module 26 may communicate with risk assessment database 24 to receive information associated with organization 11. Risk assessment database 24 includes any one or a combination of volatile or non-volatile local or remote devices suitable for storing information. For example, risk assessment database 24 may include RAM, ROM, magnetic storage devices, optical storage devices, or any other suitable information storage device or combination of these devices.

Risk analysis module 26 represents any suitable component that facilitates the analysis of risks across multiple business units in organization 11. Risk analysis module 26 receives data from data sources 18, third party database 20, vendor database 22, and/or risk assessment database 24 and analyzes the received data to identify operational risks across multiple business units of organization 11. In an embodiment, risk analysis module 26 receives unstructured data from the various sources to analyze. Additionally, risk analysis module 26 may create reports based on the analysis, and may communicate the reports to computer 12.

Risk analysis module 26 may include a network server, any suitable remote server, a mainframe, a host computer, a workstation, a web server, a personal computer, a file server, or any other suitable device operable to communicate with computers 12, data sources 18, third party database 20, vendor database 22, and/or risk assessment database 24. In some embodiments, risk analysis module 26 may execute any suitable operating system such as IBM's zSeries/Operating System (z/OS), MS-DOS, PC-DOS, MAC-OS, WINDOWS, UNIX, OpenVMS, or any other appropriate operating system, including future operating systems. The functions of risk analysis module 26 may be performed by any suitable combination of one or more servers or other components at one or more locations. In the embodiment where risk analysis module 26 is a server, the server may be a private server, or the server may be a virtual or physical server. The server may include one or more servers at the same or remote locations. Also, risk analysis module 26 may include any suitable component that functions as a server. In the illustrated embodiment, risk analysis module 26 includes a network interface 28, a processor 30, and a memory 32.

Network interface 28 represents any suitable device operable to receive information from network 16, transmit information through network 16, perform processing of information, communicate with other devices, or any combination of the preceding. For example, network interface 28 receives third party information from third party database 20. As another example, network interface 28 receives information external to organization 11 from data sources 18. As yet another example, network interface 28 may communicate reports based on the analysis of the received data to computers 12. Network interface 28 represents any port or connection, real or virtual, including any suitable hardware and/or software, including protocol conversion and data processing capabilities, to communicate through a LAN, WAN, MAN, or other communication system that allows risk analysis module 26 to exchange information with network 16, data sources 18, third party database 20, vendor database 22, risk assessment database 24, or other components of system 10.

Processor 30 communicatively couples to network interface 28 and memory 32, and controls the operation and administration of risk analysis module 26 by processing information received from network interface 28 and memory 32. Processor 30 includes any hardware and/or software that operates to control and process information. For example, processor 30 executes logic 34 to control the operation of risk analysis module 26. Processor 30 may be a programmable logic device, a microcontroller, a microprocessor, any suitable processing device, or any suitable combination of the preceding.

Memory 32 stores, either permanently or temporarily, data, operational software, or other information for processor 30. Memory 32 includes any one or a combination of volatile or non-volatile local or remote devices suitable for storing information. For example, memory 32 may include RAM, ROM, magnetic storage devices, optical storage devices, or any other suitable information storage device or a combination of these devices. While illustrated as including particular modules, memory 32 may include any suitable information for use in the operation of risk analysis module 26. In the illustrated embodiment, memory 32 includes logic 34, key risks 36, and quantified data 38.

Logic 34 generally refers to logic, rules, algorithms, code, tables, and/or other suitable instructions embodied in a computer-readable storage medium for performing the described functions and operations of risk analysis module 26. For example, logic 34 facilitates the analysis of data received by risk analysis module 26. In an embodiment, logic 34 facilitates the mapping of the received data with key risks. Additionally, logic 34 may facilitate quantifying the data.

Key risks 36 generally refer to the particular risks to which risk analysis module 26 maps the received data. For example, key risks 36 may include risks in the following areas: technology, privacy, corporate security, corporate workplace, operational losses, audit issues, and/or any other suitable area. Additionally, key risks 36 may refer to identified areas that are external to organization 11.

Within each of the areas in which risk is evaluated, there may be various risk categories. For example, risk categories may be related to people, processes, systems, external events, or other suitable areas. In an example embodiment, risk categories include: internal fraud; associate practices; talent management development; execution, servicing, and management; valuation and reporting; infrastructure and applications; data; external fraud; suppliers and third party reliance; business continuity; and geo political climate. Each risk category may have one or more associated key risks 36, to which risk analysis module 26 maps the received data. For example, the internal fraud risk category is associated with the following key risk 36: misuse of organization or client information. As another example, the talent management development risk category may be associated with the following key risks 36: employee relations, talent and staff capability, inability to retain targeted associates, co-employment risk, improper incentive compensation, and improper termination. As yet another example, the infrastructure/applications risk category may be associated with the following key risks 36: inadequate processing capacity, inadequate systems delivery, complexity, use of aging or not permitted technology, line of business managed applications, inadequate systems development life cycle infrastructure, and unstable processing capability. With respect to the data risk category, it may be associated with the following key risks 36: data security risks and data integrity, availability, and quality. Key risks 36 may be updated as necessary.

Quantified data 38 generally refers to the data that has been mapped and quantified by risk analysis module 26. Risk analysis module 26 may store quantified data 38 and may use previous versions of quantified data 38 to analyze the newly received data.

In an exemplary embodiment of operation, risk analysis module 26 receives data that is internal to organization 11 and data that is external to organization 11. Risk analysis module 26 may receive data internal to organization 11 from third party database 20, vendor database 22, and/or risk assessment database 24. Risk analysis module 26 may receive data external to organization 11 from data sources 18. In an embodiment, the internal and external data may include unstructured data regarding organization 11 and/or third parties. Additionally, the internal data relates to various business units within organization 11.

After receiving the data to analyze, risk analysis module 26 maps the various groups of data with key risks. The mapped data is compiled based on the associated key risk. Once the data is compiled into key risk groups, risk analysis module 26 quantifies the data in the key risk groups using any suitable technique. Risk analysis module 26 may generate a report based on the quantified data and communicates the report to computer 12 to facilitate additional risk analysis of organization 11.

A component of system 10 may include an interface, logic, memory, and/or other suitable element. An interface receives input, sends output, processes the input and/or output and/or performs other suitable operations. An interface may comprise hardware and/or software. Logic performs the operation of the component, for example, logic executes instructions to generate output from input. Logic may include hardware, software, and/or other logic. Logic may be encoded in one or more tangible media, such as a computer-readable medium or any other suitable tangible medium, and may perform operations when executed by a computer. Certain logic, such as a processor, may manage the operation of a component. Examples of a processor include one or more computers, one or more microprocessors, one or more applications, and/or other logic.

Modifications, additions, or omissions may be made to system 10 without departing from the scope of the invention. For example, system 10 may include any number of computers 12, data sources 18, third party databases 20, vendor databases 22, risk assessment databases 24, and risk analysis modules 26. As another example, organization 11 may include an organization credit risk database, which includes information regarding risk factors that organization 11 has in different countries. Any suitable logic may perform the functions of system 10 and the components within system 10.

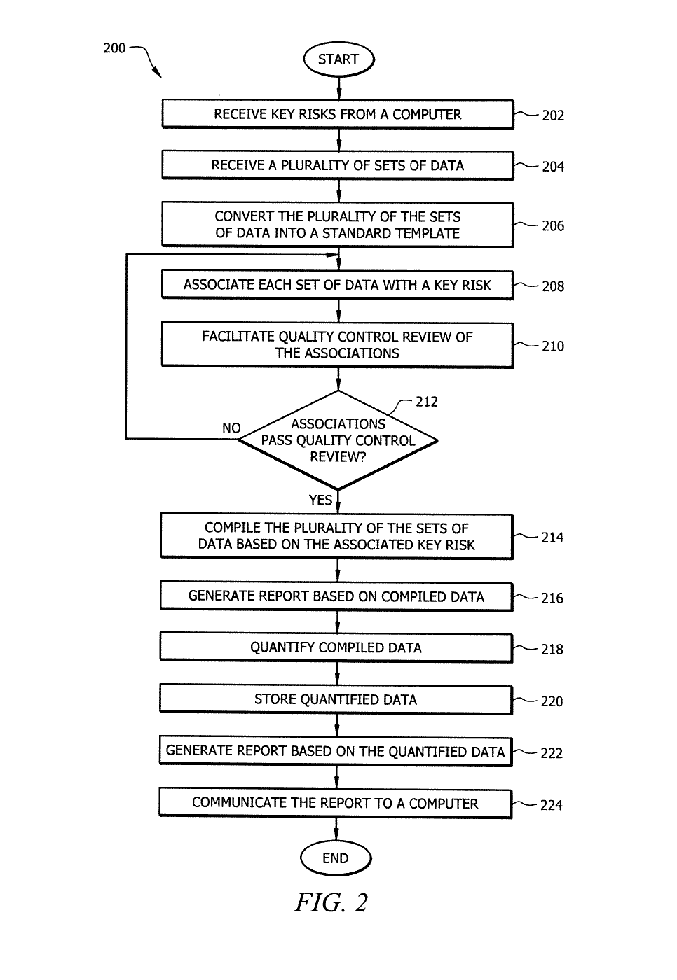

FIG. 2 illustrates a flowchart 200 for operational risk and control analysis of organization 11. At step 202, risk analysis module 26 receives key risks from computer 12. As discussed above, a key risk indicates a risk area to which data will be mapped. Risk analysis module 26 may receive the key risks from administrators within organization 11, managers of business units, operational risk managers, or any other suitable individual in organization 11 that accesses a computer 12. The key risks used by risk analysis module 26 may be reviewed periodically and updated as necessary. In an embodiment, an administrator, manager, or other individual may update the key risks based on new or additional information. In another embodiment, risk analysis module 26 may provide recommendations to computer 12 to identify additional key risks to be used to map the received data. Risk analysis module 26 may identify these additional key risks based on the received data and receiving information that may not fit into an already defined key risk.

At step 204, risk analysis module 26 receives a plurality of sets of data. The received data may be internal to organization 11 and/or external to organization 11. Additionally, the data may be structured and/or unstructured. Risk analysis module 26 receives data from data sources 18, third party database 20, vendor database 22, and/or risk assessment database 24. In an embodiment, the received data includes internal and external data regarding emerging risks that are categorized according to the following: fraud and criminal, human malicious external events, human non-malicious external events, natural events and disasters, third party and vendor, legal, and regulatory and governmental. Risk analysis module 26 may collect the data during any suitable time. For example, the data collection may occur on a periodic basis, at pre-determined periods of times, or randomly. In an embodiment, the various data providers are ranked and associated with a suggested weight. For example, a Six Sigma Analytical Hierarchical Process may be used to rank and weight the data providers. The weight associated with the data providers may be used to quantify the data, as will be discussed with respect to step 218.

At step 206, risk analysis module 26 converts the plurality of the sets of data into a standard template. Converting the data into a standard template facilitates the analysis of the data. Risk analysis module 26 associates each set of data with a key risk at step 208. To facilitate the association, risk analysis module 26 employs key word searching and/or Boolean searching. For the association, risk analysis module 26 maps the root cause of the data or incident description to a “best fit” risk.

At step 210, risk analysis module 26 facilitates a quality control review of the associations. In an embodiment, risk analysis module 26 communicates the associations to computer 12, and an associate, manager, or other suitable individual verifies the appropriateness of the automatically-generated associations.

At step 212, risk analysis module 26 determines whether the associations pass the quality control review. If the associations do not pass this review, the method continues from step 208 where the association process is re-implemented. If the associations pass the quality control review, the method continues from step 214 and risk analysis module 26 compiles the plurality of the sets of data based on the associated key risk. Risk analysis module 26 then generates a report based on the compiled data in step 216. For example, risk analysis module 26 may generate a pivot table summary of the information. As another example, the generated report may indicate how the data from the various data providers is mapped. For example, if 40% of the data regarding organizational corporate investigations is mapped to a “Misuse of Organization Information” key risk, the generated report indicates that information.

At step 218, risk analysis module 26 quantifies the compiled data. For example, risk analysis module 26 weights the compiled data based on a pre-determined weighting scheme. Each data provider may have an associated weight, and risk analysis module 26 may apply the appropriate weight to quantify the data. The appropriate weight to apply may be based on any suitable criteria. For example, sources that report violations of law may have a higher weight, or sources that represent issues related to organization 11 versus a specific business unit may have a higher weight. Other factors to consider to determine the weighting scheme include: determining whether the source provides potentially new information and/or determining whether a source contains data that requires a proactive response. Risk analysis module 26 may adjust the weighting based on the data providers, the received data, or other suitable information. Risk analysis module 26 stores the quantified data at step 220.

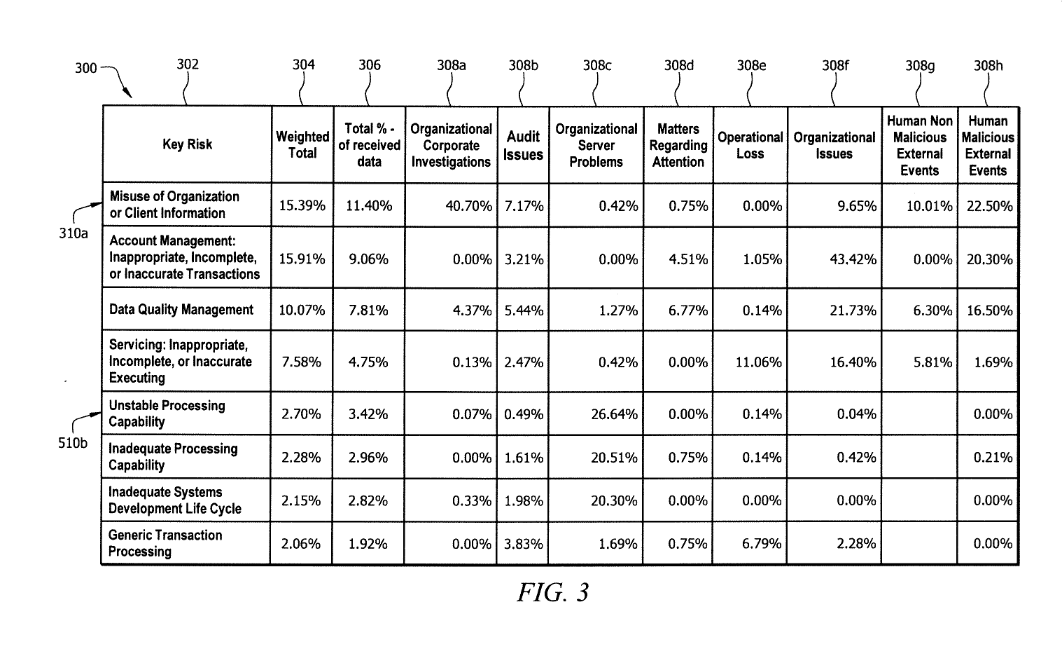

At step 222, risk analysis module 26 generates a report based on the quantified data that facilitates additional risk analysis. The report may include a summary of identified control strengths, control weaknesses to be addressed by organization 11, and/or an action plan to facilitate an improvement in business processes. Control weaknesses to address can be prioritized according to the weighting of the associated risk, or other suitable criteria. An example report will be discussed in greater detail with respect to FIG. 3.

Modifications, additions, or omissions may be made to flowchart 200 depicted in FIG. 2. The method may include more, fewer, or other steps. Additionally, steps may be performed in parallel or in any suitable order. For example, risk analysis module 26 may receive data associated with emerging risks that has been categorized between steps 216 and 218, instead of receiving the with other data sets in step 204. While discussed as risk analysis module 26 performing the steps, any suitable component of system 10 may perform one or more steps of the method.

FIG. 3 illustrates a chart 300 that provides information regarding the quantification of integrated data. Chart 300 includes key risks 36 and the quantified data associated with each key risk 36. Risk analysis module 26 creates chart 300 based on the analyzed data and communicates chart 300 to computer 12. GUI 14 of computer 12 displays chart 300 to a user.

Column 302 identifies the key risk that risk analysis module 26 will evaluate. As discussed above, an administrator may determine the key risks to evaluate and communicate this information to risk analysis module 26, or risk analysis module 26 may determine the appropriate key risks to evaluate based on the received data. Column 304 identifies the weighted total percentage of the received data that is associated with the key risk. Column 306 indicates the actual total percentage of the received data that is associated with the key risk. Columns 308a-308h indicate the data providers of the received data. For example, column 308a references data provided regarding organizational corporate investigations, column 308b references data regarding audit issues, column 308c references data provided regarding organizational server problems, column 308d references data provided regarding matters requiring attention, column 308e references data provided regarding operational losses, column 308f references data provided regarding organizational issues, column 308g references data provided regarding human non-malicious external events, and column 308h references data provided regarding human malicious external events.

Each row in chart 300 identifies a key risk and the quantifiable data associated with the key risk. For example, row 310a identifies “Misuse of Organization or Client Information” as the key risk. In column 304 of row 310a, the weighted total associated with the key risk is 15.39% and the actual total of the data associated with the key risk is 11.40% as indicated in column 306 of row 310a. The subsequent columns of row 310a indicate the percentage of data received from each data provider associated with the key risk. For example, column 308a indicates that 40.7% of the data received regarding organizational corporate investigations is associated with the “Misuse of Organization or Client Information” key risk. As another example, column 308g indicates that 10.01% of the data received regarding human non-malicious external events is associated with the “Misuse of Organization or Client Information” key risk. As another example, row 310b identifies “Unstable Processing Capability” as the key risk. The weighted total associated with this key risk is 2.70%, and the total percentage of received data associated with this key risk is 3.42%. Columns 308a-308h indicate the percentage of data received from the various data providers that are associated with “Unstable Processing Capability.”

In an embodiment, chart 300 may be shown as a heat map to visually indicate the areas of strength and weakness. For example, areas that need immediate attention may be shown in red. Areas that are of moderate priority may be shown in yellow, and areas of low priority are shown in green.

Modifications, additions, or omissions may be made to chart 300 without departing from the scope of the invention. For example, while the illustrated chart is shown as a heat map, any other visual indicator may be used to prioritize the areas for consideration. Additionally, chart 300 may include information on the risk category, the inherent risk score, Basel loss likelihoods, or any other suitable information. As another example, risk analysis module 26 may determine a change in the weighted total from a previous period and report that trending information on chart 300. Chart 300 may display whether the weighted total, or any other total, has increased, decreased, or remained the same. Additionally, chart 300 may provide comparative results between various business units within organization 11 and may provide comparative results between a business unit and the entire organization 11.

Certain embodiments of the present disclosure may provide one or more technical advantages. A technical advantage of one embodiment includes providing a system that facilitates the analysis of risk across various business units of an organization. Having the ability to analyze data across various business units facilitates a broader risk analysis. Another technical advantage of an embodiment includes analyzing data that is internal to the organization and analyzing data that is external to the organization. Again, broadening the scope of the analysis allows the organization to better understand potential risks and respond accordingly. Yet another technical advantage includes electronically gathering information from electronic data providers to provide current information regarding the external organizations, which provides more complete and accurate information for the risk analysis. Another technical advantage of an embodiment includes prioritizing the areas for improvement opportunities to facilitate development of an action plan.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. A system, comprising:
a network interface operable to:
receive a plurality of key risks, wherein the plurality of key risks identify operational risks of an organization; and
receive a plurality of sets of data from a plurality of data providers, wherein the plurality of the sets of data comprise information associated with a plurality of business units in the organization;
a processor communicatively coupled to the network interface and operable to:
associate each set of data with a key risk;
compile the plurality of the sets of data based on the key risk; and
quantify the compiled data, wherein quantifying the integrated data comprises weighting the compiled data according to the key risk; and
a memory communicatively coupled to the processor and operable to store the quantified data to facilitate risk analysis.

2. The system of claim 1, wherein the plurality of data providers comprises internal data providers and external data providers and the plurality of the sets of data comprises structured data and unstructured data.

3. The system of claim 1, wherein the plurality of the sets of data comprises data associated with the organization and data associated with a plurality of third parties and the data associated with the organization and the data associated with a plurality of third parties is categorized according to operational risk categories and the operational risk categories comprise the following categories: fraud and criminal, human malicious external events, human non-malicious external events, natural events and disasters, third party and vendor, legal, and regulatory and governmental.

4. The system of claim 1, wherein the processor is further operable to convert the plurality of the sets of data into a standard template before associating each set of data with the key risk.

5. The system of claim 1, wherein the processor is further operable to:
facilitate quality control review of the associated set of data and the key risk; and
determine whether the associated set of data and the key risk pass the quality control review.

6. The system of claim 1, wherein the processor is further operable to generate a first report based on the integrated data, wherein the first report comprises at least one pivot table.

7. The system of claim 1, wherein the processor is further operable to:
generate a second report based on the quantified data; and
communicate the second report to a computer to facilitate additional analysis.

8. Non-transitory computer readable medium comprising logic, the logic, when executed by a processor, operable to:
receive a plurality of key risks, wherein the plurality of key risks identify operational risks of an organization;
receive a plurality of sets of data from a plurality of data providers, wherein the plurality of the sets of data comprise information associated with a plurality of business units in the organization;
associate each set of data with a key risk;
compile the plurality of the sets of data based on the key risk;
quantify the compiled data, wherein quantifying the integrated data comprises weighting the compiled data according to the key risk; and
store the quantified data to facilitate risk analysis.

9. The non-transitory computer readable medium of claim 8, wherein the plurality of data providers comprises internal data providers and external data providers and the plurality of the sets of data comprises structured data and unstructured data.

10. The non-transitory computer readable medium of claim 8, wherein the plurality of the sets of data comprises data associated with the organization and data associated with a plurality of third parties and the data associated with the organization and the data associated with a plurality of third parties is categorized according to operational risk categories and the operational risk categories comprise the following categories: fraud and criminal, human malicious external events, human non-malicious external events, natural events and disasters, third party and vendor, legal, and regulatory and governmental.

11. The non-transitory computer readable medium of claim 8, wherein the logic is further operable to:
facilitate quality control review of the associated set of data and the key risk; and
determine whether the associated set of data and the key risk pass the quality control review.

12. The non-transitory computer readable medium of claim 8, wherein the logic is further operable to generate a first report based on the integrated data, wherein the first report comprises at least one pivot table.

13. The non-transitory computer readable medium of claim 8, wherein the logic is further operable to:
generate a second report based on the quantified data; and
communicate the second report to a computer to facilitate additional analysis.

14. A method, comprising:
receiving a plurality of key risks, wherein the plurality of key risks identify operational risks of an organization;
receiving a plurality of sets of data from a plurality of data providers, wherein the plurality of the sets of data comprise information associated with a plurality of business units in the organization;
associating, by a processor, each set of data with a key risk;
compiling the plurality of the sets of data based on the key risk;
quantifying, by the processor, the compiled data, wherein quantifying the integrated data comprises weighting the compiled data according to the key risk; and
storing the quantified data to facilitate risk analysis.

15. The method of claim 14, wherein the plurality of data providers comprises internal data providers and external data providers and the plurality of the sets of data comprises structured data and unstructured data.

16. The method of claim 14, wherein the plurality of the sets of data comprises data associated with the organization and data associated with a plurality of third parties and the data associated with the organization and the data associated with a plurality of third parties is categorized according to operational risk categories and the operational risk categories comprise the following categories: fraud and criminal, human malicious external events, human non-malicious external events, natural events and disasters, third party and vendor, legal, and regulatory and governmental.

17. The method of claim 14, further comprising converting the plurality of the sets of data into a standard template before associating each set of data with the key risk.

18. The method of claim 14, further comprising:
facilitating quality control review of the associated set of data and the key risk; and
determining, by the processor, whether the associated set of data and the key risk pass the quality control review.

19. The method of claim 14, further comprising generating a first report based on the integrated data, wherein the first report comprises at least one pivot table.

20. The method of claim 14, further comprising:
generating a second report based on the quantified data; and
communicating the second report to a computer to facilitate additional analysis.
